(19) United States
(12) Patent Application Publication
(10) Pub. No.: US 2021/0335119 A1
(43) Pub. Date: Oct. 28, 2021

(54) PERSONAL PROPERTY PROXIMITY MONITOR

(71) Applicant: Armen Hakobyan, Glendale, CA (US)

(72) Inventor: Armen Hakobyan, Glendale, CA (US)

(21) Appl. No.: 16/859,656

(22) Filed: Apr. 27, 2020

(51) Int. Cl. G08B 21/24; A45B 3/00; G08B 7/06

(52) U.S. Cl. CPC G08B 21/24; G08B 7/06; A45B 3/00

(57) ABSTRACT

An advisory system for assuring that a person dependent upon a particular personal article not become separated from the personal article by excessive distance is shown and described. The system may include a body worn component and another component coupled to the monitored personal article. The components can sense distance of separation and generate an alarm when a predetermined separation exists. One component may be incorporated into the personal article, the latter being a walking cane for example. The predetermined distance of separation may be adjustable. The alarm may be visible, audible, vibratory, may comprise a reproduced human voice, or may be a combination of these. Battery power may rely on a rechargeable or renewable battery.

### FIELD OF THE INVENTION

The present invention relates to communications, and more particularly, to an electrically powered monitor capable of sensing and signaling proximity of a person to a particular personal object, e.g., for the purpose of assuring that the person not unknowingly become separated from the personal object.

### BACKGROUND OF THE INVENTION

People become dependent upon diverse personal objects for personal mobility, security, and other purposes. Illustratively, a person may be dependent upon a cane, walker, or other personal property in order to be ambulatory or otherwise function in the course of daily routine. It is easy to set down a personal object and effectively become separated therefrom. This may present significant problems in mobility or personal security, especially for people who are partially incapacitated.

There exists a need for apparatus capable of monitoring proximity of a person to an article of personal property on which the person may be dependent, and for signaling when a distance of separation threatens to become excessive.

### SUMMARY OF THE INVENTION

The present invention addresses the above need by providing apparatus including a first component removably attachable to a personal article being monitored, and an associated second component worn on the body of the person associated with the monitored article. The first and second components can communicate with one another. The apparatus includes an arrangement for sensing a selectable distance of separation between the first and second components, and issuing an alarm when the selectable distance becomes exceeded.

The present invention provides improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an environmental diagrammatic side view of exemplary apparatus for sensing and signaling distance of separation between a personal and a personal article, according to at least one aspect of the invention;

FIG. 2 is a diagrammatic side view of novel apparatus;

FIG. 3 is an enlarged side view of the exemplary apparatus integrated into a cane;

FIG. 4 is a diagrammatic perspective view of one component of an apparatus for sensing and signaling distance of separation between a personal and a personal article, according to at least a further aspect of the invention;

FIG. 5 is a diagrammatic perspective view of a component of an apparatus for sensing and signaling distance of separation between a personal and a personal article, according to at least another aspect of the invention;

FIG. 6 is a diagrammatic perspective view of a component of an apparatus for sensing and signaling distance of separation between a personal and a personal article, according to yet a further aspect of the invention;

FIG. 7 is an electrical schematic showing electrical components of the invention, according to at least one aspect of the invention;

FIG. 8 is a diagrammatic side perspective detail view of a component of the invention, according to a further aspect of the invention; and

FIG. 9 is a diagrammatic perspective view of a component of the invention, according to still a further aspect of the invention.

### DETAILED DESCRIPTION

The present invention contemplates an advisory system for assuring that a person dependent upon a particular personal article not become separated from the personal article by excessive distance.

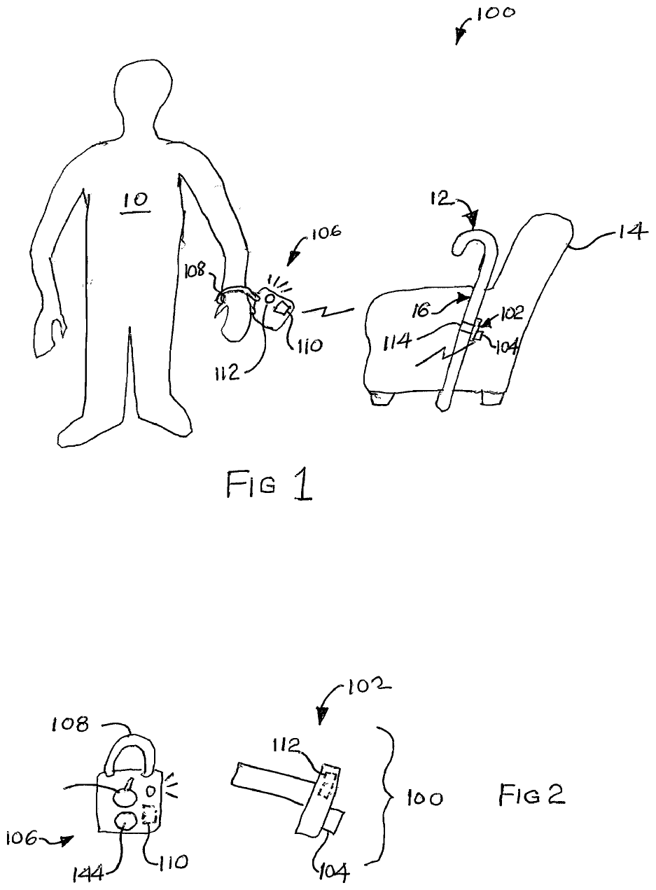

Referring first to FIG. 1, according to at least one aspect of the invention, there is shown apparatus 100 for sensing and signaling distance of separation between a person 10 and a personal article 12 associated with person 10. Apparatus 100 may comprise a first component 102 in contact with personal article 12. First component 102 may comprise a first wireless signaling device 104. Apparatus 100 may also comprise a second component 106 to be worn on the body of person 10 associated with personal article 12. Second component 106 may comprise a mechanical connector 108 removably engageable with person 10. Apparatus 100 may also comprise a second wireless signaling device 110 having capability of communicating with first wireless signaling device 104. Note that first component 102 and second component 106 may be waterproof or otherwise weather resistant.

Apparatus 100 further comprises an alarm 112 activable by one of first component 102 and second component 106, for annunciating that a predetermined distance of separation between first component 102 and second component 106 has been exceeded. Apparatus 100 also comprises an arrangement for sensing a selectable distance of separation between first component 102 and second component 106, and issuing a signal activating alarm 112 when the selectable distance becomes exceeded.

Personal article 12 may be an ambulatory device such as a walking cane 16, a walker, or one or more crutches, a communications device such as a portable telephone handset, a cellular telephone, or headphones, a medically needed device such as an inhaler, an illumination device such as a flashlight, a child, a pet, a purse or wallet, recreational equipment such as a golf bag or club, keys or electronic access device, an article of apparel of the type frequently removed such as a hat or scarf, a book, a portable computing device such as a laptop computer, a navigational aid such as a GPS unit, visibility aid such as glasses or binoculars, a carrier such as a briefcase, packaged food, protective gear such as an umbrella, or a firearm, by way of examples. These examples are well known objects and other than cane 16 are not illustrated.

Where personal article is cane 16, first mechanical connector 114 is configured to releasably engage cane 16.

The invention is conceptually illustrated in FIGS. 1 and 2. FIG. 1 shows a representative environmental view of one implementation of the invention. In FIG. 1, person 10 is shown wearing second component 106 on the arm. The arm is shown in purely representative capacity as second compartment may be coupled to the torso, around the neck, on a leg, etc. Mechanical connector 108 in the example of FIG. 1 may be an elastic tether for example. In other implementations, mechanical connector may comprise a flexible strap, a chain, an anchor for engaging a buttonhole of an article of apparel, a patch of hook and loop fastening material for engaging a corresponding patch on the body of person 10 or for engaging fabrics having integral filamentary loops or pile, latchable arms, and other types, or any feasible combination of these. In the example illustrated in FIGS. 1 and 2, mechanical connector 108 comprises a wrist strap.

In the example of FIG. 1, personal article 12 has been laid against a chair 14. Because it is possible for person 10 to become so engrossed in activities as to forget where personal article 12 (in this example, a cane 16) has been placed, apparatus 100 will prevent effective loss of personal article 12 by alerting person 10 before the latter has moved so far from personal article 12 that regaining possession of personal article 12 may become unduly burdensome.

This is accomplished by communication between first and second signaling devices 104, 110. Each of first and second signaling devices 104, 110 may include a low powered transmitter and a receiver (not separately shown). One transmitter may send a first signal, with the other transmitter sending a reply signal responsively. The first transmitter may have signal power recognition capability. When the return or reply signal falls below a predetermined threshold, alarm 112 of second component (FIG. 1) is activated.

In an alternative embodiment shown in FIG. 2, alarm 112 may be located with first component 102. Therefore, it will be understood that operative components of apparatus 100 may be distributed in different ways between first and second components 102, 106 so as to effect operation as described herein. It will further be understood that the various components will be provided with operating power by a suitable battery or other source, and with circuitry making necessary connections among the various components to enable operation as described herein, even if such components and circuitry are not specifically shown.

In the example of FIG. 1, mechanical connector 108 of second component 106 is a second mechanical connector 108, and first component 104 comprises a first mechanical connector 114 configured to removably engage personal article 12. First mechanical connector 114 may be of any of the types described with reference to second mechanical connector 108. This does not imply that first and second mechanical connectors 114, 108 need be of the same type.

Turning to FIG. 3, in one implementation of the invention different from those of FIGS. 1 and 2, first component 102 may be integrated with personal article 12, and may be fully contained within personal article 12.

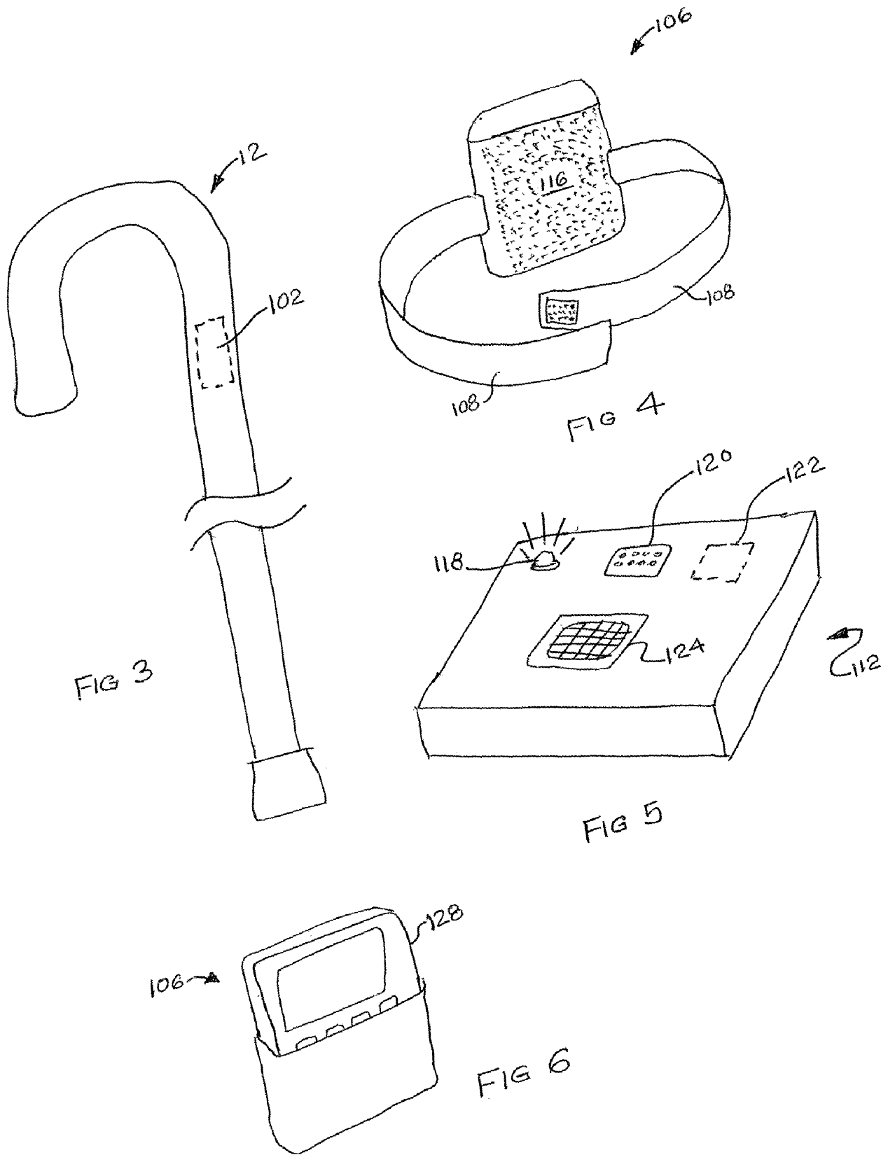

As shown in FIG. 4, second component 106 may have a hypoallergenic surface 116.

Referring now to FIG. 5, alarm 112 may be at least one of visible, audible, vibratory, and voice generating. These options are represented by indicating light 118, buzzer 120, vibrator 122, and speaker 124. It would also be possible to provide more than one of the listed alarm output devices. Notably, alarm 112 may includes a voice generating first alarm 124 and a second alarm, wherein the second alarm is one of visible, audible, and vibratory (e.g., as represented as indicating light 118, buzzer 120, or vibrator 122). The latter combination is particularly advantageous in cases wherein person 10 has a degree of dementia or Alzheimer's disease. It has been found that dementia and Alzheimer's disease patients respond more favorably to a familiar voice, compared to a buzzer or other generic alarm sounds.

Referring again to FIG. 2, the arrangement for sensing the selectable distance of separation between first component 102 and second component 106 may be adjustable and capable of selecting different distances of separation. In one option, a dial 126 may increase and decrease a threshold of signal reception, so that a weaker received response signal causes a determination by an electronic circuit (not shown) of greater distance of separation. When response signal weakness crosses an adjusted threshold, alarm 112 is activated.

Looking now at FIG. 6, second component 106 may comprise a cellular telephone 128. First wireless signaling device 104 of first component 102 may be arranged to initiate a telephone call signal to cellular telephone 128 when a threshold of signal reception determines that the predetermined distance of separation is being met or exceeded.

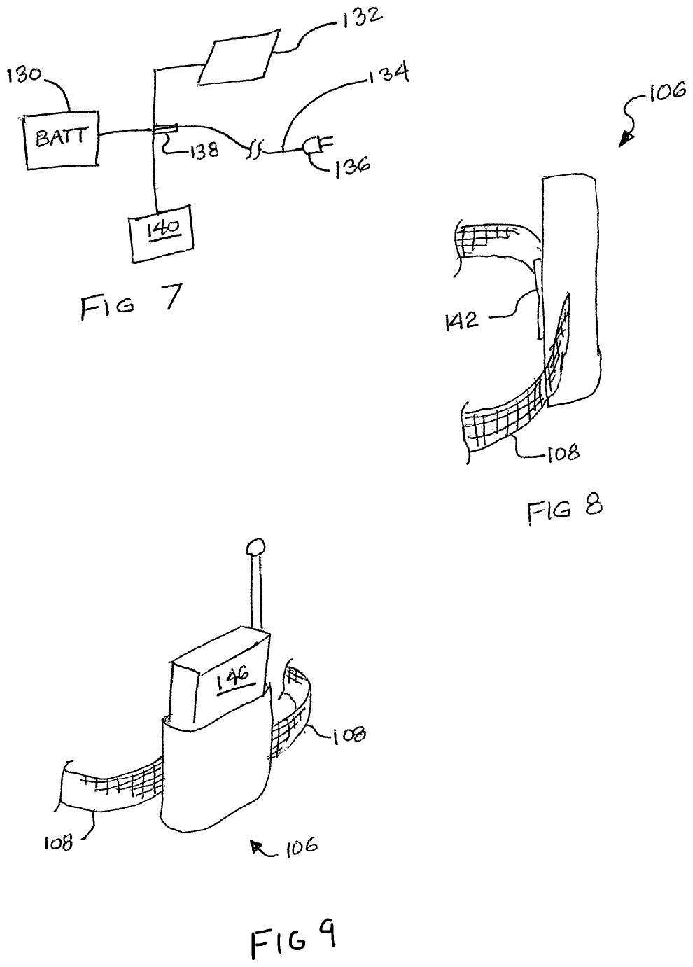

Turning to FIG. 7, in apparatus 100, at least one of first component 102 and second component 106 includes a battery 130 and a charging feature configured to charge battery 130. The charging feature may comprises at least one replaceable battery 130. That is, battery 130 and a housing (not separately shown) of respective first or second component 102 or 106 may be configured to enable battery 130 to be slid into and removed from place within the housing, making necessary electrical contact for operability in a fully installed position. Where not relying on manual removal and replacement of battery 130, the charging feature may comprise a photovoltaic generating element 132, a flexible jacketed conductor 134 includes a first terminal 136 compatible with a standard 120V AC household power receptacle (not shown), and a second terminal 138 comprising universal service bus terminal. In a further option, the charging feature may comprise a wireless power transfer receiver 140.

Turning now to FIG. 8, second component 106 may further comprise a heart pulse rate monitor 142 in communication with alarm 112. In the example of FIG. 8, second mechanical connector 108 comprises straps configured to encircle the arm of person 10. Heart pulse rate monitor 142 is on the inside of second component 106; that is, the side against the arm, so that heart pulse rate monitor 142 can make suitable contact with the arm for sensing pulse rate. In this example, alarm 112 may be located within second component 106.

Returning to FIG. 2, second component 106 may further comprise an emergency assistance feature configured to contact a 911 emergency response facility, the emergency assistance feature operable by a single touch actuator 144.

Turning to FIG. 9, second component 106 may further comprise a self-contained bidirectional wireless communications device such as a walkie-talkie 146 or other low powered communications device intended for direct signal transmission to a similar device within relatively close proximity (e.g., three hundred feet).

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

1. Apparatus for sensing and signaling distance of separation between a person and personal article associated with the person, the apparatus comprising:
a first component in contact with the personal article, the first component comprising a first wireless signaling device; and
a second component to be worn on the body of the person associated with the personal article, the second component comprising
a mechanical connector removably engageable with the person, and
a second wireless signaling device having capability of communicating with the first wireless signaling device;
a first alarm activable by one of the first component and the second component, for annunciating that a predetermined distance of separation between the first component and the second component has been exceeded, wherein the alarm is a recording of a voice that is recognizable and familiar to the person rather than a buzzer or other generic alarm
a second alarm activable by one of the first component and the second component, wherein the second alarm is triggered a predetermined time after the first alarm has not been responded to, wherein the second alarm is one of visible, audible, and vibratory; and
an arrangement for sensing a selectable distance of separation between the first component and the second component, and issuing a signal activating the alarm when the selectable distance becomes exceeded.

2. The apparatus of claim 1, wherein the mechanical connector of the second component is a second connector, and the first component comprises a first mechanical connector configured to removably engage the personal article.

3. The apparatus of claim 2, wherein the first component is integrated with the personal article.

4. (canceled)

5. The apparatus of claim 1, wherein the second component has a hypoallergenic surface.

6. (canceled)

7. (canceled)

8. The apparatus of claim 1, wherein the arrangement for sensing the selectable distance of separation between the first and second components is adjustable and capable of selecting different distances of separation.

9. The apparatus of claim 1, wherein the second component comprises a cellular telephone.

10. The apparatus of claim 1, wherein at least one of the first component and the second component includes a battery and a charging feature configured to charge the battery.

11. The apparatus of claim 10, wherein the charging feature comprises at least one replaceable battery.

12. The apparatus of claim 10, wherein the charging feature comprises a photovoltaic generating element.

13. The apparatus of claim 10, wherein the charging feature comprises a flexible jacketed conductor including a first terminal compatible with a household power receptacle and a second terminal comprising universal service bus terminal.

14. The apparatus of claim 10, wherein the charging feature comprises a wireless power transfer receiver.

15. The apparatus of claim 1, wherein the second component further comprises a heart pulse rate monitor in communication with the alarm.

16. The apparatus of claim 15, wherein the second component further comprises an emergency assistance feature configured to contact a 911 emergency response facility, the emergency assistance feature operable by a single touch actuator.

17. The apparatus of claim 16, wherein the second component further comprises a self-contained bidirectional wireless communications device.

18. The apparatus of claim 1, wherein the first component is configured to releasably engage the personal article.
